(19) United States
(12) Patent Application Publication
(10) Pub. No.: US 2026/0356728 A1
(43) Pub. Date: Nov. 12, 2026

(54) DRILLING APPARATUS AND DRILLING METHOD

(71) Applicant: SUMITOMO ELECTRIC INDUSTRIES, LTD., Osaka (JP)

(72) Inventors: Takuji NAGASHIMA, Osaka (JP); Tetsuya HAYASHI, Osaka (JP)

(21) Appl. No.: 19/632,678

(22) Filed: Mar. 30, 2026

(30) Foreign Application Priority Data
May 12, 2025 (JP) 2025-079885

(51) Int. Cl. C03B 37/012

(52) U.S. Cl. CPC C03B 37/01231; C03B 2203/34

(57) ABSTRACT

A drilling apparatus according to the present disclosure includes: a machining tool extending along a longitudinal direction of a workpiece having a cylindrical shape to form at least one hole at an arbitrary position on an end face of the workpiece; a spindle that is disposed at a position facing the end face in the longitudinal direction and rotatably holds the machining tool; a steady rest member disposed between the end face and the spindle in the longitudinal direction to prevent runout of the machining tool; a first drive mechanism that moves the workpiece relative to the spindle and the steady rest member in a direction orthogonal to the longitudinal direction; and a second drive mechanism that moves at least one of the workpiece and the spindle in the longitudinal direction.

### CROSS REFERENCE

The present application claims priority based on Japanese Patent Application No. 2025-079885 filed on May 12, 2025, the entire contents of which are incorporated herein by reference.

### TECHNICAL FIELD

The present disclosure relates to a drilling apparatus and a drilling method.

### BACKGROUND

For example, when a multicore fiber preform is manufactured, a glass material having a cylindrical shape that will serve as a clad is prepared, and a plurality of holes are formed on an end face of the glass material. A core rod is inserted into each of the plurality of holes formed in the glass material. The glass material is then integrated with each of the core rods by heating to thus obtain a multicore fiber preform. The multicore fiber preform is thereafter drawn to obtain a multicore fiber.

A longer multicore fiber preform results in a longer multicore fiber obtained from one multicore fiber preform, and thus provides an improvement in productivity of the multicore fiber. For a same amount of misalignment of the core in the stage of a multicore fiber preform, a larger diameter of the multicore fiber preform leads to higher accuracy in the core position of the finally obtained multicore fiber. Therefore, an increase in size of a multicore fiber preform enables improvement in productivity and achievement of high quality of a multicore fiber. Producing a large-size multicore fiber preform requires an increased diameter and an increased length of a glass material that will serve as a clad, and requires a technique to form a large-diameter and long hole with high accuracy at an arbitrary position of the glass material.

A gun drill machine is typically known as a drilling apparatus for forming a deep hole in a long workpiece (see, e.g., Japanese Unexamined Patent Publication No. 2010-284771). In a gun drill machine, a spindle having a long machining tool mounted thereon is moved toward a workpiece to thereby form a deep hole in the workpiece. The machining tool is often provided with a steady rest member for preventing runout of the machining tool.

### SUMMARY

A drilling apparatus according to the present disclosure includes: a machining tool extending along a longitudinal direction of a workpiece having a cylindrical shape to form at least one hole at an arbitrary position on an end face of the workpiece; a spindle that is disposed at a position facing the end face in the longitudinal direction and rotatably holds the machining tool; a steady rest member disposed between the end face and the spindle in the longitudinal direction to prevent runout of the machining tool; a first drive mechanism that moves the workpiece relative to the spindle and the steady rest member in a direction orthogonal to the longitudinal direction to cause the machining tool to face, in the longitudinal direction, the end face at the arbitrary position on the end face; and a second drive mechanism that moves at least one of the workpiece and the spindle in the longitudinal direction to cause the at least one hole to be formed at an arbitrary position on the end face by the machining tool.

### BRIEF DESCRIPTION OF THE DRAWINGS

FIG. 1 is a diagram schematically illustrating a drilling apparatus according to an embodiment.

FIG. 2 is a diagram illustrating an example of a drilling process performed using the drilling apparatus of FIG. 1.

FIG. 3 is a diagram illustrating a step that follows the step of FIG. 2.

FIG. 4 is a diagram illustrating a step that follows the step of FIG. 3.

FIG. 5 is a diagram illustrating a step that follows the step of FIG. 4.

FIG. 6 is a diagram illustrating an end face of a workpiece having a plurality of holes formed therein by a drilling method performed using the drilling apparatus of FIG. 1.

FIG. 7 is a diagram illustrating an example of a manufacturing process for a multicore fiber preform using the workpiece of FIG. 6.

FIG. 8 is a diagram illustrating a step that follows the step of FIG. 7.

FIG. 9 is a diagram schematically illustrating a drilling apparatus according to modification 1.

FIG. 10 is a diagram schematically illustrating a drilling apparatus according to modification 2.

FIG. 11 is a diagram schematically illustrating a drilling apparatus according to modification 3.

FIG. 12 is a diagram schematically illustrating a drilling apparatus according to a comparative example.

### DETAILED DESCRIPTION

In a gun drill machine, the drive shaft for forming a hole in the longitudinal direction of the workpiece is usually only one shaft along the longitudinal direction of the workpiece except for the spindle that rotates for rotating the machining tool. When a hole for inserting a core rod is to be formed in a glass material having a cylindrical shape that will serve as a clad of a multicore fiber preform using such a gun drill machine, it is required to move the machining tool to an arbitrary position on an end face of the glass material, and thus to increase the number of drive shafts.

When such a glass material is used as a workpiece, it is conceivable that, for example, the spindle for holding the machining tool is allowed to be driven in a direction perpendicular to the longitudinal direction of the workpiece in addition to being driven in the longitudinal direction of the workpiece. In this case, it is conceivable that the steady rest member for preventing runout of the machining tool is also allowed to be driven in the direction perpendicular to the longitudinal direction of the workpiece in synchronization with movement of the spindle. However, the spindle often has a heavy structure for stably holding the machining tool, and such heavy machine component is difficult to position accurately. Therefore, it is not easy to maintain the synchronization between the spindle and the steady rest member, and the parallelism of the machining tool with respect to the workpiece may decrease depending on the accuracy of the synchronization. This may cause a large misalignment between the machining starting end and the machining ending end in the workpiece created by the machining tool. Therefore, with such a configuration, it is difficult to accurately form a hole at an arbitrary position on an end face of the workpiece.

The present disclosure provides a drilling apparatus and a drilling method that enable a hole to be accurately formed at an arbitrary position on an end face of a workpiece.

According to a drilling apparatus and a drilling method of the present disclosure, a hole can be accurately formed at an arbitrary position on an end face of a workpiece.

Details of an embodiment of the present disclosure will next be described.
(1) A drilling apparatus according to an embodiment of the present disclosure includes a machining tool extending along a longitudinal direction of a workpiece having a cylindrical shape to form at least one hole at an arbitrary position on an end face of the workpiece, a spindle disposed at a position facing the end face in the longitudinal direction, the spindle rotatably holding the machining tool, a steady rest member disposed between the end face and the spindle in the longitudinal direction to prevent runout of the machining tool, a first drive mechanism that moves the workpiece relative to the spindle and the steady rest member in a direction orthogonal to the longitudinal direction to cause the machining tool to face, in the longitudinal direction, the end face at the arbitrary position on the end face, and a second drive mechanism that moves at least one of the workpiece and the spindle in the longitudinal direction to cause the at least one hole to be formed at the arbitrary position on the end face by the machining tool.
   The drilling apparatus of item (1) includes a first drive mechanism that moves the workpiece relative to the spindle and the steady rest member in a direction orthogonal to the longitudinal direction of the workpiece to cause at least one hole to be formed at an arbitrary position on an end face of the workpiece by the machining tool. As described above, in a case where the workpiece is moved, rather than the spindle and the steady rest member, in the direction orthogonal to the longitudinal direction, this eliminates the need for moving the spindle and the steady rest member in such direction in synchronization with each other, thereby reducing factors that degrade the parallelism of the machining tool with respect to the workpiece due to misalignment between the spindle and the steady rest member. This can reduce the likelihood that a large misalignment is caused between the machining starting end and the machining ending end of the workpiece by the machining tool. Accordingly, the drilling apparatus of item (1) enables a hole to be accurately formed at an arbitrary position on an end face of a workpiece.
(2) In the drilling apparatus according to item (1), the steady rest member and the spindle have a relative position therebetween in the direction orthogonal to the longitudinal direction, and the relative position may be maintained during a time period in which the at least one hole is formed at the arbitrary position on the end face by the machining tool. In this case, the posture of the machining tool can be stabilized by the spindle and the steady rest member, thereby enabling a hole to be formed more accurately at an arbitrary position on an end face of the workpiece by the machining tool.
(3) In the drilling apparatus according to item (1) or (2), the workpiece and the steady rest member have a relative position therebetween in the longitudinal direction, and the relative position may be maintained during a time period in which the at least one hole is formed at the arbitrary position on the end face by the machining tool. With progress of formation of the hole in the workpiece by the machining tool, the leading end of the machining tool moves away from the steady rest member in the longitudinal direction of the workpiece, which is likely to cause a large amount of runout of the leading end of the machining tool. Therefore, it is desirable that the steady rest member be disposed as close as possible to the workpiece in the longitudinal direction to reduce runout of the leading end of the machining tool. The configuration described in item (3) enables the relative position between the workpiece and the steady rest member in the longitudinal direction to be maintained to cause the steady rest member to be disposed as close as possible to the workpiece in the longitudinal direction. Therefore, even when formation of the hole in the workpiece by the machining tool progresses, the likelihood of causing a large amount of runout of the leading end of the machining tool is reduced, thereby enabling machining of the workpiece by the machining tool to be stably performed. As a result, a hole can be formed more accurately at an arbitrary position on an end face of the workpiece using the machining tool.
(4) In the drilling apparatus according to item (3), the second drive mechanism may move the workpiece and the steady rest member relative to the spindle in the longitudinal direction while maintaining the relative position between the workpiece and the steady rest member in the longitudinal direction. Since the spindle is a heavy, precision-critical machine component, the workpiece can be more stably machined by the machining tool by providing, for the workpiece and the steady rest member, a mechanism that moves the workpiece and the steady rest member in the longitudinal direction rather than providing, for the foregoing machine component, a mechanism that moves the foregoing machine component in the longitudinal direction. As a result, a hole can be formed more accurately at an arbitrary position on an end face of the workpiece using the machining tool.
(5) The drilling apparatus according to item (4) may further comprise a first support member that supports the first drive mechanism on which the workpiece is placed, and a second support member that supports the spindle. The steady rest member may be fixed to the first support member at a position spaced apart from the end face of the workpiece in the longitudinal direction by a predetermined distance. The second drive mechanism may move the first support member in the longitudinal direction. In this case, a configuration can be easily formed that moves the workpiece and the steady rest member relative to the spindle in the longitudinal direction while maintaining the relative position between the workpiece and the steady rest member in the longitudinal direction.
(6) In the drilling apparatus according to item (3), the second drive mechanism may move the spindle relative to the workpiece and the steady rest member in the longitudinal direction while maintaining the relative position between the workpiece and the steady rest member in the longitudinal direction. This avoids an increase in the complexity and size of the configuration for moving the workpiece as compared with the case where the workpiece is moved in the longitudinal direction thereof and in the direction orthogonal to the longitudinal direction.
(7) The drilling apparatus according to item (6) may further include a first support member that supports the first drive mechanism on which the workpiece is placed, and a second support member that supports the spindle. The steady rest member may be fixed to the first support member at a position spaced apart from the end face of the workpiece in the longitudinal direction by a predetermined distance. The second drive mechanism may move the second support member in the longitudinal direction. In this case, a configuration can be easily formed that moves the spindle relative to the workpiece and the steady rest member in the longitudinal direction while maintaining the relative position between the workpiece and the steady rest member in the longitudinal direction.
(8) In the drilling apparatus according to any one of items (1) to (7), the workpiece may be disposed to have the longitudinal direction thereof aligned with a horizontal direction parallel to an installation surface when the drilling apparatus has been installed on the installation surface. The spindle may hold the machining tool while the machining tool is disposed along the horizontal direction. Disposition of the machining tool along a horizontal direction instead of along the vertical direction in this manner can reduce the possibility that the drilling apparatus becomes excessively tall in the vertical direction depending on the length of the workpiece. This enables the mechanical stability and maintainability of the drilling apparatus to be maintained at a high level.
(9) In the drilling apparatus according to any one of items (1) to (7), the workpiece may be disposed to have the longitudinal direction thereof aligned with a vertical direction perpendicular to an installation surface when the drilling apparatus has been installed on the installation surface. The spindle may hold the machining tool while the machining tool is disposed along the vertical direction. Disposition of the machining tool along the vertical direction instead of along a horizontal direction in this manner can reduce the possibility that the machining tool may bend due to the influence of gravity, thereby enabling machining of the workpiece by the machining tool to be stabilized. As a result, a hole can be formed more accurately at an arbitrary position on an end face of the workpiece using the machining tool.
(10) In the drilling apparatus according to any one of items (1) to (9), the workpiece may be a glass material that will serve as a clad of a multicore fiber preform. The at least one hole may be a plurality of holes that allow a plurality of respective core rods to be inserted into the plurality of holes, wherein the core rods are to serve as a plurality of cores of the multicore fiber preform. When such a workpiece is used, there is a need to adjust the relative position between the workpiece and the machining tool in the direction orthogonal to the longitudinal direction of the workpiece to form a plurality of holes at arbitrary positions on the end face of the workpiece, in which case the effect described in association with item (1) can therefore be experienced to a sufficient degree.
(11) A drilling method according to an embodiment of the present disclosure includes a step of preparing a machining tool extending along a longitudinal direction of a workpiece having a cylindrical shape, a spindle disposed at a position facing an end face of the workpiece in the longitudinal direction and configured to rotatably hold the machining tool, and a steady rest member disposed between the end face and the spindle in the longitudinal direction; a step of moving the workpiece relative to the spindle and the steady rest member in a direction orthogonal to the longitudinal direction to cause the machining tool to face, in the longitudinal direction, the end face at an arbitrary position on the end face; and a step of moving at least one of the workpiece or the spindle in the longitudinal direction to cause at least one hole to be formed at the arbitrary position on the end face by the machining tool. In this drilling method, instead of the spindle and the steady rest member, the workpiece is moved in the direction orthogonal to the longitudinal direction, thereby enabling the effect described in association with item (1) to be obtained.

### Details of Embodiment of Present Disclosure

Specific examples of a drilling apparatus and a drilling method according to an embodiment of the present disclosure will be described below with reference to the drawings. The present disclosure is not limited to these examples, but is indicated by the claims, and is intended to include all modifications within the meaning and scope equivalent to the claims. In the following description, the same elements are denoted by the same reference signs in the description of the drawings, and redundant description will be omitted as appropriate.

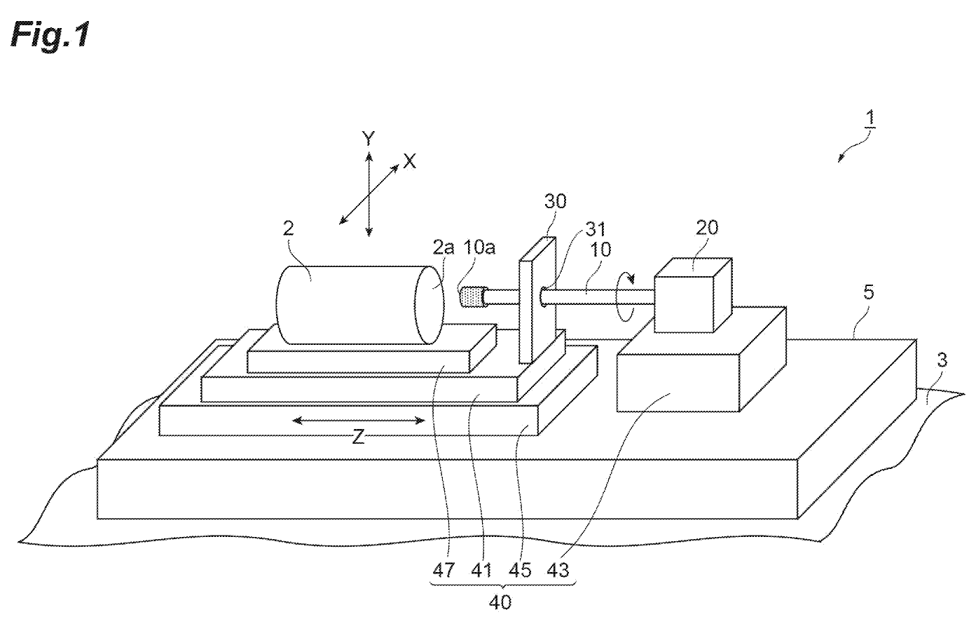

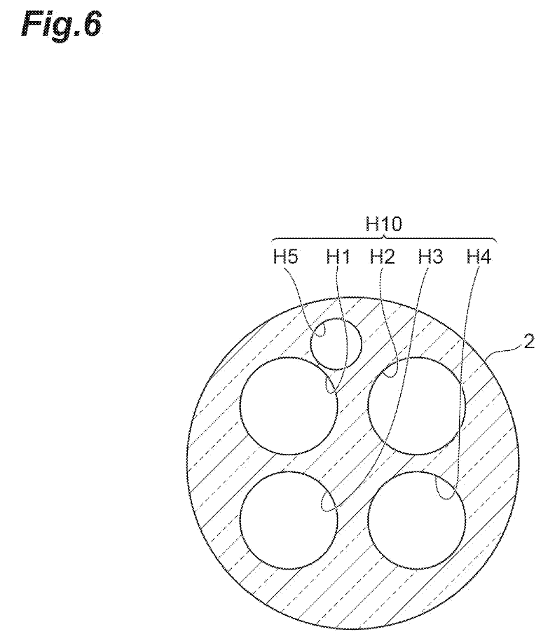

A drilling apparatus 1 illustrated in FIG. 1 is an apparatus that forms a plurality of holes H10 (see FIG. 6) at arbitrary positions on an end face 2a of a workpiece 2. The drilling apparatus 1 is installed on a predetermined floor surface 3 (installation surface). The workpiece 2 is, for example, a glass material that will serve as a clad of a multicore fiber preform, and is formed of, for example, quartz glass. The workpiece 2 has, for example, a cylindrical shape and has a central axis extending along a longitudinal direction thereof. That the workpiece 2 has a cylindrical shape means that the workpiece 2 has a cross-sectional shape that is circular in a cross section orthogonal to the longitudinal direction of the workpiece 2. The term circular as used herein means generally circular, and includes perfectly circular, circular nearly perfectly circular, and circular partly with a straight line.

The workpiece 2 has the end face 2a located at a first end in the longitudinal direction. The end face 2a is, for example, a plane perpendicular to the longitudinal direction. Performing drilling on the end face 2a by the drilling apparatus 1 causes the plurality of holes H10 to be formed on the end face 2a at positions where the plurality of cores and a marker of the multicore fiber preform are to be formed.

As illustrated in FIG. 1, the drilling apparatus 1 includes, for example, a base 5, a machining tool 10, a spindle 20, a steady rest member 30, and a moving mechanism 40. The moving mechanism 40 includes, for example, a workpiece support table 41 (first support member), a headstock 43 (second support member), a first drive mechanism 47, and a second drive mechanism 45.

In the following description, a longitudinal direction in which the workpiece 2 extends is referred to as a Z direction; one of directions orthogonal to the longitudinal direction is referred to as an X direction; and the direction orthogonal to the X direction among the directions orthogonal to the longitudinal direction is referred to as a Y direction. In the present embodiment, the Z direction is along a horizontal direction, and the Y direction is along the vertical direction when the drilling apparatus 1 has been installed on the floor surface 3.

The base 5 is placed on the floor surface 3. The floor surface 3 extends along the X direction and the Z direction. The workpiece support table 41, which supports the workpiece 2, and the headstock 43, which supports the spindle 20, are placed on the base 5. Each of the workpiece support table 41 and the headstock 43 is, for example, a plate-like member extending along the X direction and the Z direction. On the base 5, the headstock 43 is aligned with the workpiece support table 41 along the Z direction. The workpiece support table 41 supports the workpiece 2 to have the longitudinal direction of the workpiece 2 aligned with the Z direction.

The spindle 20 faces, in the Z direction, the end face 2a of the workpiece 2 placed on the workpiece support table 41 while being supported by the headstock 43. The spindle 20 holds the machining tool 10 such that a leading end 10a of the machining tool 10 faces the end face 2a of the workpiece 2 in the Z direction. The machining tool 10 is an elongated drill for forming the plurality of holes H10 at arbitrary positions on the end face 2a of the workpiece 2. The machining tool 10 has, for example, a cylindrical shape extending along the Z direction. The machining tool 10 has a central axis extending along the Z direction similarly to the workpiece 2. The machining tool 10 is held by a chuck mechanism of the spindle 20. The spindle 20 is provided to be rotatable by a spindle motor. Rotation of the spindle 20 causes the machining tool 10 mounted on the spindle 20 to rotate about its rotation axis.

The steady rest member 30 is disposed between the end face 2a of the workpiece 2 and the spindle 20 in the Z direction. The steady rest member 30 is a member for preventing runout of the machining tool 10. The steady rest member 30 is, for example, a plate-like member extending along the X direction and the Y direction. The steady rest member 30 may have a through hole 31. The through hole 31 penetrates the steady rest member 30 in the Z direction. The through hole 31 allows the machining tool 10 extending from the spindle 20 toward the end face 2a of the workpiece 2 to pass therethrough. The through hole 31 has an inner diameter greater than the outer diameter of the machining tool 10 to such an extent that runout of the machining tool 10 can be prevented. The steady rest member 30 does not need to have the through hole 31. When not having the through hole 31, the steady rest member 30 may include a mechanism that physically holds the machining tool 10 with a force that will not hinder the rotation of the machining tool 10.

The steady rest member 30 is disposed at a position spaced apart from the end face 2a of the workpiece 2 in the Z direction by a predetermined distance, and is fixed to the workpiece support table 41. The steady rest member 30 is, for example, integrated with the workpiece support table 41, but may be formed separately from the workpiece support table 41. The steady rest member 30 is fixed to the workpiece support table 41, thereby causing the distance between the steady rest member 30 and the workpiece 2 in the Z direction to be kept constant.

The workpiece support table 41 is supported by the second drive mechanism 45. The second drive mechanism 45 is disposed between the workpiece support table 41 and the base 5. The second drive mechanism 45 moves the workpiece support table 41 in the Z direction. The second drive mechanism 45 includes, for example, a guide rail extending along the Z direction, a ball screw for moving the workpiece support table 41 along the guide rail, and a servomotor connected to the ball screw. Therefore, the workpiece 2 supported by the workpiece support table 41 and the steady rest member 30 are movable in the Z direction by the second drive mechanism 45.

The workpiece 2 is supported by the first drive mechanism 47. The first drive mechanism 47 is disposed between the workpiece 2 and the workpiece support table 41. The first drive mechanism 47 moves the workpiece 2 in the X direction and in the Y direction. The first drive mechanism 47 includes, for example, a movable table that supports the workpiece 2, a ball screw for moving the movable table along the X direction and the Y direction, and a servomotor connected to the ball screw. Therefore, the workpiece 2 is movable in the X direction and in the Y direction by the first drive mechanism 47.

Meanwhile, the spindle 20 is, for example, fixed to the base 5 so as not to move in the X direction, the Y direction, or the Z direction. Therefore, in the present embodiment, the workpiece 2 is movable in the X direction, the Y direction, and the Z direction; the steady rest member 30 is movable only in the Z direction; and the spindle 20 is not movable in any direction. As described above, the moving mechanism 40 moves the workpiece 2 in the X direction and in the Y direction instead of moving the spindle 20 and the steady rest member 30 in the X direction and in the Y direction. Since the steady rest member 30 moves in the Z direction together with the workpiece 2, the relative position between the steady rest member 30 and the workpiece 2 in the Z direction is maintained. Since the steady rest member 30 and the spindle 20 do not move in the X direction or in the Y direction, the relative positions between the steady rest member 30 and the spindle 20 in the X direction and in the Y direction are maintained.

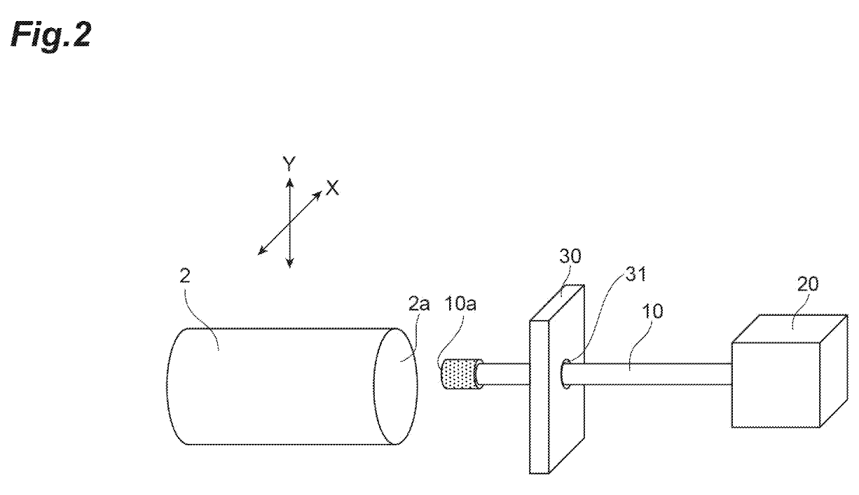

A drilling method performed using the drilling apparatus 1 will next be described with reference to FIGS. 2-5. For ease of understanding, FIGS. 2-5 illustrate only the workpiece 2, the steady rest member 30, and the spindle 20 holding the machining tool 10, which are main elements whose movement is controlled by the moving mechanism 40, and omit elements other than these elements.

First, as illustrated in FIG. 2, the workpiece 2 to be drilled, the spindle 20 holding the machining tool 10, and the steady rest member 30 are prepared. Then, the workpiece 2 moves relative to the spindle 20 and the steady rest member 30 in the X direction and in the Y direction to cause the leading end 10a of the machining tool 10 to face, in the Z direction, a position on the end face 2a of the workpiece 2 where a first core of the multicore fiber preform is to be formed. The workpiece 2 is caused to move in the X direction and in the Y direction by the above-described first drive mechanism 47 (see FIG. 1).

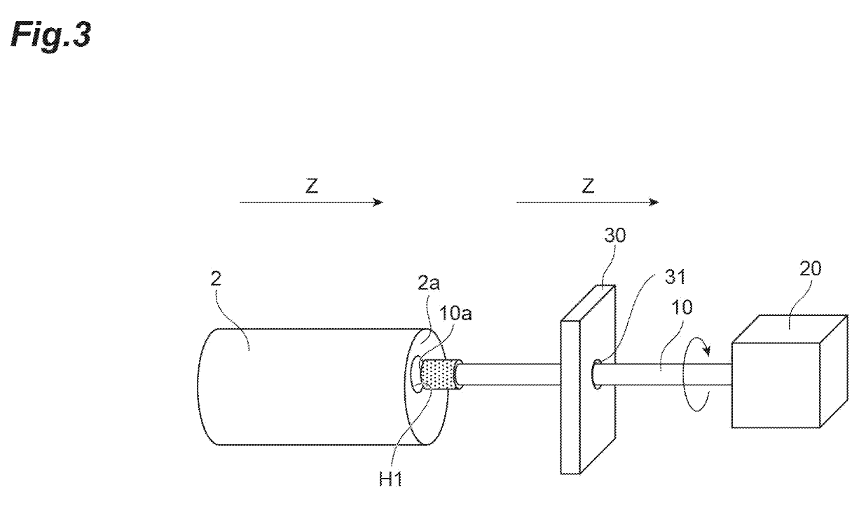

Next, as illustrated in FIG. 3, the workpiece 2 and the steady rest member 30 move relative to the spindle 20 in the Z direction. Specifically, while the spindle 20 is fixed so as not to move, both the workpiece 2 and the steady rest member 30 move in the Z direction in a direction that causes the leading end 10a of the machining tool 10 to approach the end face 2a of the workpiece 2. The workpiece 2 and the steady rest member 30 are caused to move in the Z direction by the above-described second drive mechanism 45 (see FIG. 1).

Movement of the workpiece 2 in a direction that causes the end face 2a of the workpiece 2 to approach the leading end 10a of the machining tool 10 causes the end face 2a to be drilled by the machining tool 10. As a result, a first hole H1 is formed on the end face 2a. During a time period in which the first hole H1 is formed on the end face 2a by the machining tool 10, the relative position between the workpiece 2 and the steady rest member 30 in the Z direction is maintained, and the relative positions between the steady rest member 30 and the spindle 20 in the X direction and in the Y direction are maintained.

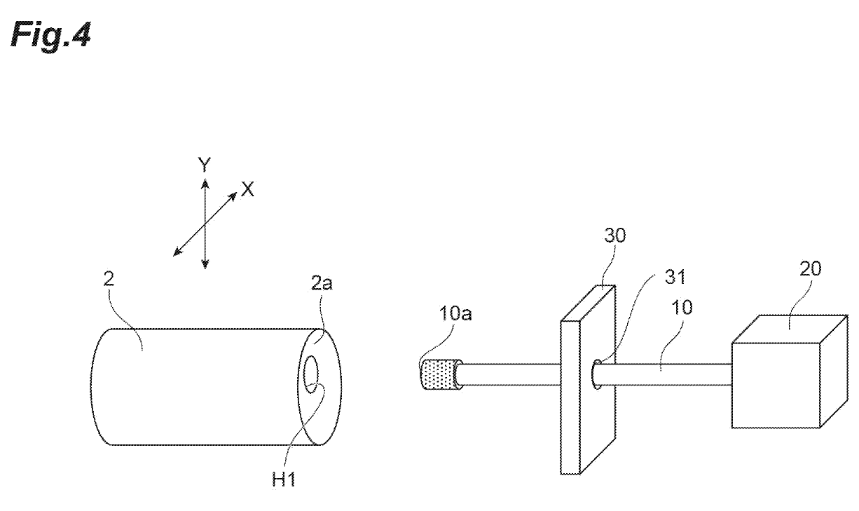

Next, as illustrated in FIG. 4, the workpiece 2 moves relative to the spindle 20 and the steady rest member 30 in the X direction and in the Y direction to cause the leading end 10a of the machining tool 10 to face, in the Z direction, a position on the end face 2a of the workpiece 2 where a second core of the multicore fiber preform is to be formed.

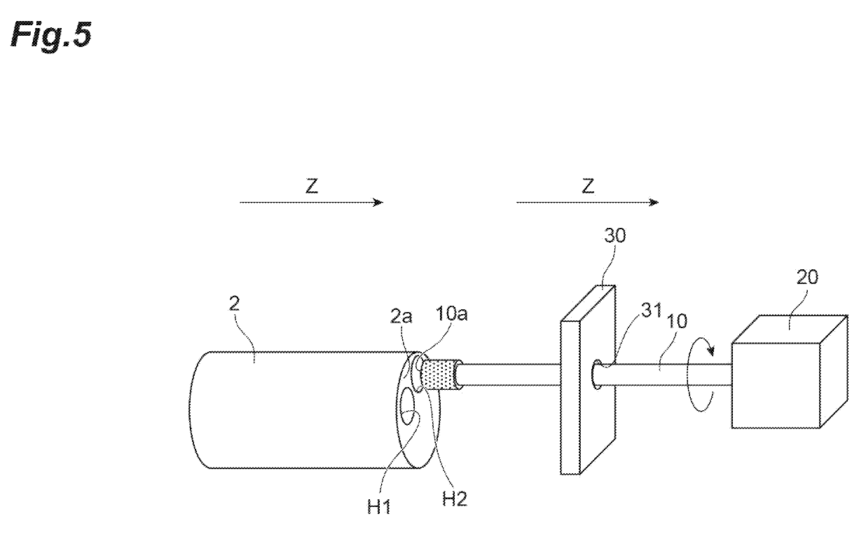

Next, as illustrated in FIG. 5, the workpiece 2 and the steady rest member 30 move relative to the spindle 20 in the Z direction. Movement of the workpiece 2 in a direction that causes the end face 2a of the workpiece 2 to approach the leading end 10a of the machining tool 10 causes the end face 2a to be drilled by the machining tool 10. As a result, a second hole H2 is formed on the end face 2a.

The above operation is repeatedly performed on a position where a third core of the multicore fiber preform is to be formed and on a position where a fourth core is to be formed on the end face 2a of the workpiece 2, whereby the first hole H1, the second hole H2, a third hole H3, and a fourth hole H4 are formed on the end face 2a of the workpiece 2 as illustrated in FIG. 6. A similar operation is performed on a position where the marker is to be formed on the end face 2a of the workpiece 2, whereby a fifth hole H5 is formed on the end face 2a of the workpiece 2.

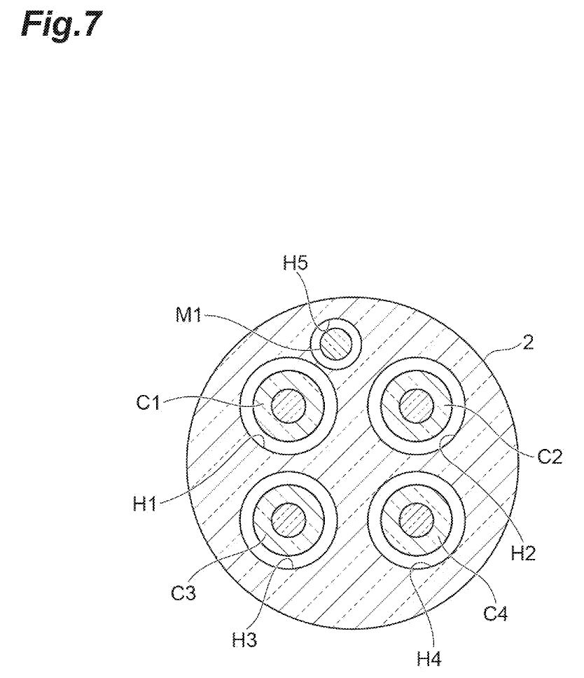

As a result, the workpiece 2 (glass material) is obtained that has the plurality of holes H10 including the first hole H1, the second hole H2, the third hole H3, the fourth hole H4, and the fifth hole H5 formed therein. The glass material having the plurality of holes H10 formed therein may hereinafter be referred to as a common clad tube. As illustrated in FIG. 7, a first core rod C1, a second core rod C2, a third core rod C3, and a fourth core rod C4 are respectively inserted into the first hole H1, the second hole H2, the third hole H3, and the fourth hole H4.

Each of the first core rod C1, the second core rod C2, the third core rod C3, and the fourth core rod C4 includes a core and an optical clad surrounding the core. A marker M1 is inserted into the fifth hole H5. To make each of the cores of the multicore fiber preform identifiable, the marker M1 is disposed at a position that breaks the symmetry of the core arrangement. The fifth hole H5 has an inner diameter smaller than the inner diameters of the first hole H1, the second hole H2, the third hole H3, and the fourth hole H4.

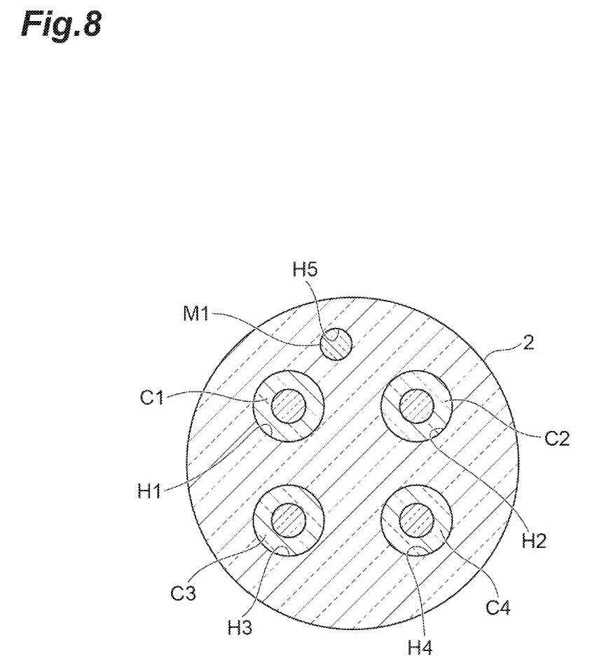

Thereafter, the common clad tube is heated while the gaps between the first core rod C1, the second core rod C2, the third core rod C3, the fourth core rod C4, and the marker M1 and the common clad tube are decompressed, whereby the multicore fiber preform illustrated in FIG. 8 is obtained. The multicore fiber preform is drawn to obtain a multicore fiber including a plurality of cores.

Effects obtained by the drilling apparatus 1 and the drilling method of the present embodiment described above will now be described together with problems involved in a comparative example.

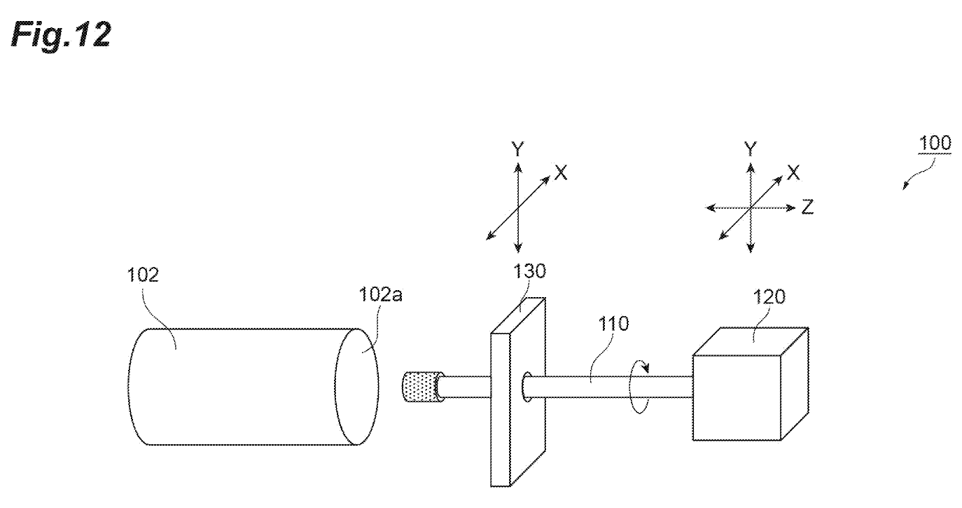

In a drilling apparatus 100 of a comparative example illustrated in FIG. 12, a workpiece 102 is not moved but is fixed, and a spindle 120 holding a machining tool 110 and a steady rest member 130 for preventing runout of the machining tool 110 move in the X direction and in the Y direction to cause the machining tool 110 to face an arbitrary position on an end face 102a of the workpiece 102. The spindle 120 and the steady rest member 130 then move in the Z direction to perform formation of a hole in the end face 102a by the machining tool 110. In the case where both the spindle 120 and the steady rest member 130 move in the X direction and in the Y direction as in the drilling apparatus 100, accurate synchronization is required between the spindle 120 and the steady rest member 130 in the X direction and in the Y direction.

However, the spindle 120 often has a heavy structure for stably holding the machining tool 110, and such heavy machine component is difficult to position accurately. Therefore, it is not easy to maintain synchronization between the spindle 120 and the steady rest member 130, and this may cause a large misalignment between the spindle 120 and the steady rest member 130 in the X direction and in the Y direction. In this case, parallelism of the machining tool 110 with respect to the workpiece 102 may decrease. This may cause a large misalignment by the machining tool 110 between the machining starting end and the machining ending end of the workpiece 102. Therefore, it is difficult for the drilling apparatus 100 to accurately form a hole at an arbitrary position on the end face 102a of the workpiece 102.

In contrast, the drilling apparatus of the present embodiment includes the first drive mechanism 47, which moves the workpiece 2 relative to the spindle 20 and the steady rest member 30 in the X direction and in the Y direction to cause the holes H10 to be formed at arbitrary positions on the end face 2a of the workpiece 2 by the machining tool 10. As described above, in a case where the workpiece 2 is moved, rather than the spindle 20 and the steady rest member 30, in the X direction and in the Y direction, this eliminates the need for moving the spindle 20 and the steady rest member 30 in these directions in synchronization with each other, thereby enabling a reduction of the factor of lowering parallelism of the machining tool 10 with respect to the workpiece 2 due to misalignment between the spindle 20 and the steady rest member 30. This can reduce the likelihood that a large misalignment is caused between the machining starting end and the machining ending end of the workpiece 2 by the machining tool 10. Accordingly, the drilling apparatus 1 can accurately form the holes H10 to be accurately formed at arbitrary positions on the end face 2a of the workpiece 2.

As in the present embodiment, the steady rest member 30 and the spindle 20 have a relative position therebetween in each of the X direction and the Y direction, where the relative position may be maintained during a time period in which the holes H10 are formed at arbitrary positions on the end face 2a by the machining tool 10. In this case, the posture of the machining tool 10 can be stabilized by the spindle 20 and the steady rest member 30, thereby enabling the holes H10 to be formed more accurately at arbitrary positions on the end face 2a of the workpiece 2 by the machining tool 10.

As in the present embodiment, the workpiece 2 and the steady rest member 30 have a relative position therebetween in the Z direction, where the relative position may be maintained during a time period in which the holes H10 are formed at arbitrary positions on the end face 2a by the machining tool 10. With progress of formation of the holes H10 in the workpiece 2 by the machining tool 10, the leading end 10a of the machining tool 10 moves away from the steady rest member 30 in the Z direction, which is likely to cause a large amount of runout of the leading end 10a of the machining tool 10. Therefore, it is desirable that the steady rest member 30 be disposed as close as possible to the workpiece 2 in the Z direction to reduce runout of the leading end 10a of the machining tool 10. In the present embodiment, the relative position between the workpiece 2 and the steady rest member 30 in the Z direction can be maintained to cause the steady rest member 30 to be disposed as close as possible to the workpiece 2 in the Z direction. Therefore, even when formation of the holes H10 in the workpiece 2 by the machining tool 10 progresses, the likelihood of causing a large amount of runout of the leading end 10a of the machining tool 10 is reduced, thereby enabling machining of the workpiece 2 by the machining tool 10 to be stably performed. As a result, the holes H10 can be formed more accurately at arbitrary positions on the end face 2a of the workpiece 2 using the machining tool 10.

As in the present embodiment, the second drive mechanism 45 may move the workpiece 2 and the steady rest member 30 relative to the spindle 20 in the Z direction while maintaining the relative position between the workpiece 2 and the steady rest member 30 in the Z direction. Since the spindle 20 is a heavy, precision-critical machine component, the workpiece 2 can be more stably machined by the machining tool 10 by providing, for the workpiece 2 and the steady rest member 30, a mechanism that moves the workpiece 2 and the steady rest member 30 in the Z direction rather than providing, for the foregoing machine component, a mechanism that moves the foregoing machine component in the Z direction. As a result, the holes H10 can be formed more accurately at arbitrary positions on the end face 2a of the workpiece 2 using the machining tool 10.

As in the present embodiment, the steady rest member 30 may be fixed to the workpiece support table 41 at a position spaced apart from the end face 2a of the workpiece 2 in the Z direction by a predetermined distance. The second drive mechanism 45 may move the workpiece support table 41 in the Z direction. In this case, a configuration can be easily formed that moves the workpiece 2 and the steady rest member 30 relative to the spindle 20 in the Z direction while maintaining the relative position between the workpiece 2 and the steady rest member 30 in the Z direction.

As in the present embodiment, the workpiece 2 may be disposed to have the Z direction aligned with a horizontal direction when the drilling apparatus 1 has been installed on the floor surface 3. The spindle 20 may hold the machining tool 10 while the machining tool 10 is disposed along the horizontal direction. Disposition of the machining tool 10 along a horizontal direction instead of along the vertical direction in this manner can reduce the possibility that the drilling apparatus 1 reaches an excessively high position in the vertical direction depending on the length of the workpiece 2. This enables the mechanical stability and maintainability of the drilling apparatus 1 to be maintained at a high level.

As in the present embodiment, the workpiece 2 may be a glass material that will serve as a clad of a multicore fiber preform. The plurality of holes H10 into which a plurality of respective core rods (e.g., the first core rod C1, the second core rod C2, the third core rod C3, and the fourth core rod C4) that will serve as a plurality of cores of a multicore fiber preform can be inserted may be formed on the end face 2a of the workpiece 2. When such workpiece 2 is used, there is a need to adjust the relative position between the workpiece 2 and the machining tool 10 in the X direction and in the Y direction to form the plurality of holes H10 at arbitrary positions in the end face 2a of the workpiece 2, in which case the foregoing effect can therefore be experienced to a sufficient degree.

The drilling apparatus and the drilling method of the present disclosure are not limited to the above-described embodiment, and can be modified without departing from the spirit and scope of the claims.

### Modification 1

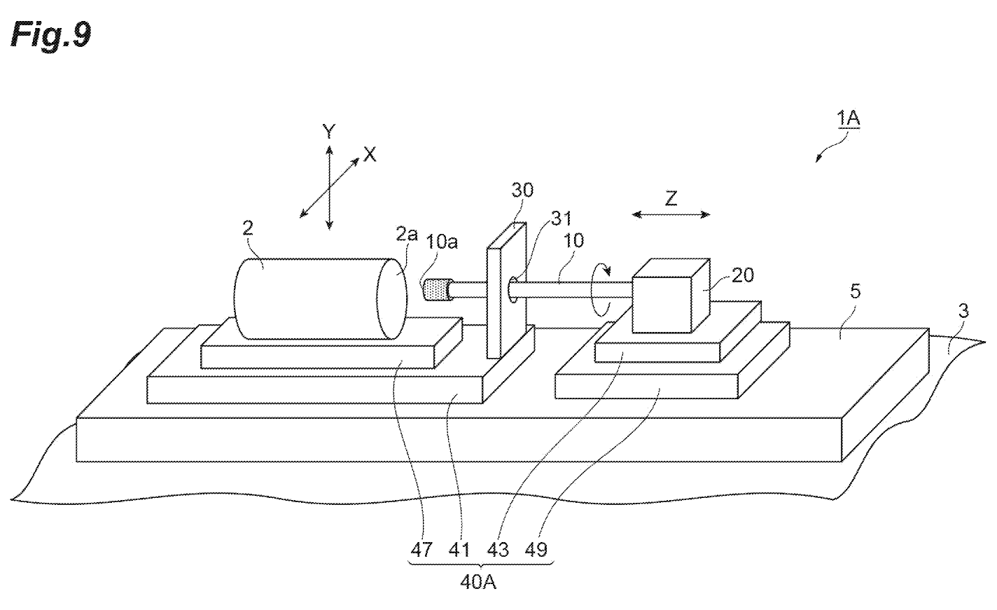

A drilling apparatus 1A illustrated in FIG. 9 includes a moving mechanism 40A instead of the moving mechanism 40. The moving mechanism 40A is the same as the moving mechanism 40 in moving the workpiece 2 in the X direction and in the Y direction, but is different from the moving mechanism 40 in moving, in the Z direction, the spindle 20 instead of the workpiece 2.

The moving mechanism 40A includes the workpiece support table 41, the headstock 43, the first drive mechanism 47, and a second drive mechanism 49. The workpiece 2 is placed on the first drive mechanism 47, and the first drive mechanism 47 is placed on the workpiece support table 41. The steady rest member 30 is fixed to the workpiece support table 41. The first drive mechanism 47 moves the workpiece 2 in the X direction and in the Y direction. The workpiece support table 41 is fixed to the base 5. Therefore, the workpiece 2 and the steady rest member 30 supported by the workpiece support table 41 do not move in the Z direction.

The second drive mechanism 49 is disposed between the headstock 43 and the base 5. The headstock 43 is placed on the second drive mechanism 49. The second drive mechanism 49 moves the headstock 43 in the Z direction. The spindle 20 supported by the headstock 43 is therefore movable in the Z direction by the second drive mechanism 49. In the drilling apparatus 1A, the workpiece 2 is movable in the X direction and in the Y direction; the steady rest member 30 is not movable in any direction; and the spindle 20 is movable only in the Z direction. Since neither the workpiece 2 nor the steady rest member 30 moves in the Z direction, the relative position between the steady rest member 30 and the workpiece 2 in the Z direction is maintained. Since the steady rest member 30 and the spindle 20 do not move in the X direction or in the Y direction, the relative positions between the steady rest member 30 and the spindle 20 in the X direction and in the Y direction are maintained.

When the drilling apparatus 1A performs drilling on the workpiece 2, the workpiece 2 moves relative to the spindle 20 and the steady rest member 30 in the X direction and in the Y direction to cause the leading end 10a of the machining tool 10 to face, in the Z direction, a position of the end face 2a of the workpiece 2 where a core of the multicore fiber preform is to be formed. Next, the spindle 20 moves relative to the workpiece 2 and the steady rest member 30 in the Z direction. Movement of the spindle 20 holding the machining tool 10 in the Z direction in a direction that causes the leading end 10a of the machining tool 10 to approach the end face 2a of the workpiece 2 causes the end face 2a to be drilled by the machining tool 10. During a time period in which a hole is formed on the end face 2a by the machining tool 10, the relative position between the workpiece 2 and the steady rest member 30 in the Z direction is maintained, and the relative positions between the steady rest member 30 and the spindle 20 in the X direction and in the Y direction are maintained.

In the drilling apparatus 1A, the workpiece 2 instead of the spindle 20 moves in the X direction and in the Y direction, thereby enabling an effect to be provided that is similar to the effect of the drilling apparatus 1 described above. In the drilling apparatus 1A, the second drive mechanism 49 moves the spindle 20 relative to the workpiece 2 and the steady rest member 30 in the Z direction while maintaining the relative position between the workpiece 2 and the steady rest member 30 in the Z direction. This enables the configuration for moving the workpiece 2 to avoid undergoing an increase in complexity and in size as compared with the case where the workpiece 2 is moved in the three directions, that is, the X direction, the Y direction, and the Z direction. In the drilling apparatus 1A, the steady rest member 30 is fixed to the workpiece support table 41 at a position spaced apart from the end face 2a of the workpiece 2 in the Z direction by a predetermined distance. The second drive mechanism 49 moves the headstock 43 in the Z direction. In this case, a configuration that moves the spindle 20 relative to the workpiece 2 and the steady rest member 30 in the Z direction while maintaining the relative position between the workpiece 2 and the steady rest member 30 in the Z direction can be easily formed.

### Modification 2

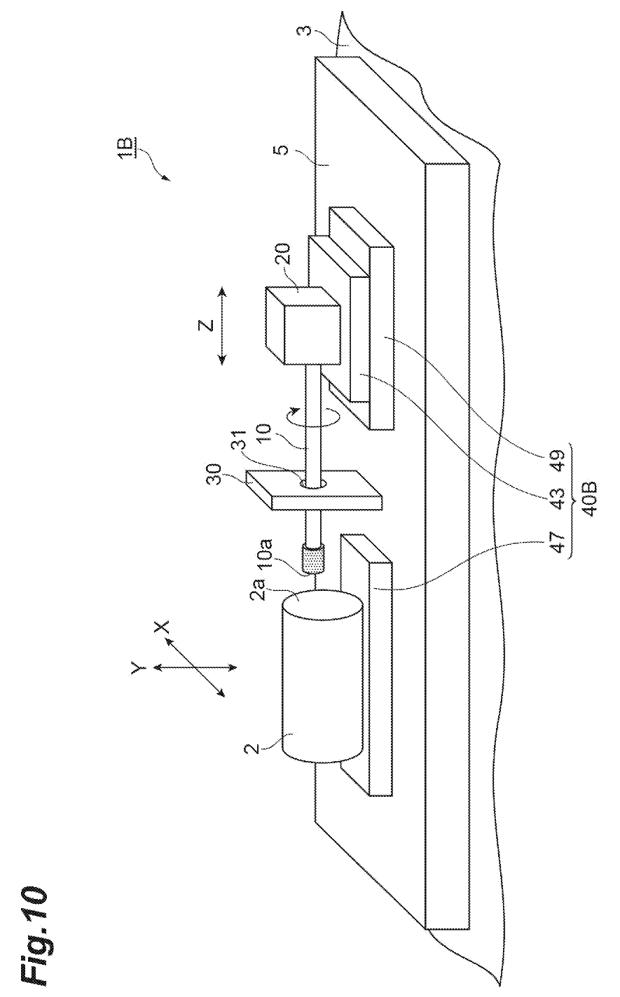

A drilling apparatus 1B illustrated in FIG. 10 includes a moving mechanism 40B instead of the moving mechanism 40. The moving mechanism 40B is different from the moving mechanism 40A in that the workpiece support table 41, which supports the workpiece 2 and the steady rest member 30, is not provided. The moving mechanism 40B includes the headstock 43, the first drive mechanism 47, and the second drive mechanism 49. In the drilling apparatus 1B, the first drive mechanism 47, which supports the workpiece 2, and the steady rest member 30 are fixed to the base 5. Also, in the drilling apparatus 1B, the workpiece 2 instead of the spindle 20 moves in the X direction and in the Y direction, thereby enabling an effect to be provided that is similar to the effect of the drilling apparatus 1 described above.

### Modification 3

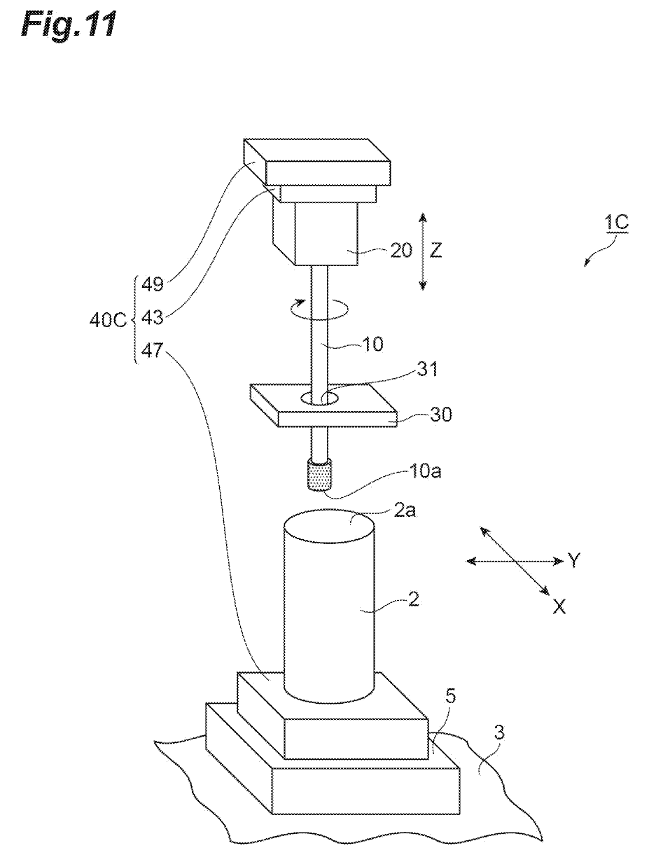

In a drilling apparatus 1C illustrated in FIG. 11, the workpiece 2 is disposed along a vertical direction perpendicular to the floor surface 3. The spindle 20 holds the machining tool 10 such that the machining tool 10 extends along the vertical direction. The drilling apparatus 1C includes a moving mechanism 40C instead of the moving mechanism 40. The moving mechanism 40C includes the headstock 43, the first drive mechanism 47, and the second drive mechanism 49.

The workpiece 2 is placed on the first drive mechanism 47, and the first drive mechanism 47 is fixed to the base 5. The relative position between the steady rest member 30 and the workpiece 2 in the Z direction is maintained. Therefore, the workpiece 2 and the steady rest member 30 are disposed not to move in the Z direction. The second drive mechanism 49 supports the headstock 43. The second drive mechanism 49 moves the headstock 43 in the Z direction. The spindle 20 supported by the headstock 43 is therefore movable in the Z direction by the second drive mechanism 49. Since the steady rest member 30 and the spindle 20 do not move in the X direction or in the Y direction, the relative positions between the steady rest member 30 and the spindle 20 in the X direction and in the Y direction are maintained.

In the drilling apparatus 1C, the workpiece 2 instead of the spindle 20 moves in the X direction and in the Y direction, thereby enabling an effect to be provided that is similar to the effect of the drilling apparatus 1 described above. In the drilling apparatus 1C, the workpiece 2 is disposed to have the Z direction aligned with the vertical direction perpendicular to the floor surface 3. The spindle 20 holds the machining tool 10 with the machining tool 10 disposed along the vertical direction. Disposition of the machining tool 10 along the vertical direction instead of along a horizontal direction in this manner can reduce the possibility that the machining tool 10 may bend due to the influence of gravity, thereby enabling machining of the workpiece 2 by the machining tool 10 to be stabilized. As a result, the holes H10 can be formed more accurately at arbitrary positions on the end face 2a of the workpiece 2 using the machining tool 10.

The present disclosure is not limited to the above-described embodiment or modifications, and various other modifications are possible.

For example, the above-described embodiment and modifications may be combined with each other according to a necessary purpose and effect without causing inconsistency.

In the above-described embodiment, the “workpiece” to be drilled by the drilling apparatus is exemplified by a glass material that will serve as the clad of a multicore fiber preform, but the “workpiece” of the present disclosure may be a member other than a glass material as long as that material is a member in which at least one hole is formed at an arbitrary position on an end face thereof. In the above-described embodiment, a case has been exemplified where the “workpiece” or the “spindle” moves in the Z direction, but, as long as the positions of the “workpiece” and the “spindle” can be adjusted in a direction that causes the leading end of the machining tool to approach the end face of the “workpiece”, both the “workpiece” and the “spindle” may move in the Z direction.

In the above-described embodiment, the case is exemplified where both the “workpiece” and the “steady rest member” are supported by the “first support member”, and the “first support member” is moved in the longitudinal direction by the “second drive mechanism”, but both the “workpiece” and the “steady rest member” need not be supported by the “first support member”. In this case, a support member may be individually provided for each of the “workpiece” and the “steady rest member”, and a drive mechanism for moving a corresponding one of the “workpiece” and the “steady rest member” in the longitudinal direction may be individually provided for each of the support members. In this case, it is required to move the “workpiece” and the “steady rest member” in the longitudinal direction in synchronization with each other.

1. A drilling apparatus comprising:
a machining tool extending along a longitudinal direction of a workpiece having a cylindrical shape, the machining tool configured to form at least one hole at an arbitrary position on an end face of the workpiece;
a spindle disposed at a position facing the end face in the longitudinal direction, the spindle configured to rotatably hold the machining tool;
a steady rest member disposed between the end face and the spindle in the longitudinal direction, the steady rest member configured to prevent runout of the machining tool;
a first drive mechanism configured to move the workpiece relative to the spindle and the steady rest member in a direction orthogonal to the longitudinal direction to cause the machining tool to face, in the longitudinal direction, the end face at the arbitrary position on the end face; and
a second drive mechanism configured to move at least one of the workpiece and the spindle in the longitudinal direction to cause the at least one hole to be formed at the arbitrary position on the end face by the machining tool.

2. The drilling apparatus according to claim 1, wherein
the steady rest member and the spindle have a relative position in the direction orthogonal to the longitudinal direction, the relative position being maintained during a time period in which the at least one hole is formed at the arbitrary position on the end face by the machining tool.

3. The drilling apparatus according to claim 1, wherein
the workpiece and the steady rest member have a relative position in the longitudinal direction, the relative position being maintained during a time period in which the at least one hole is formed at the arbitrary position on the end face by the machining tool.

4. The drilling apparatus according to claim 3, wherein
the second drive mechanism moves the workpiece and the steady rest member relative to the spindle in the longitudinal direction while maintaining the relative position between the workpiece and the steady rest member in the longitudinal direction.

5. The drilling apparatus according to claim 4, further comprising:
a first support member configured to support the first drive mechanism, on which the workpiece is placed; and
a second support member configured to support the spindle, wherein
the steady rest member is fixed to the first support member at a position spaced apart from the end face of the workpiece in the longitudinal direction by a predetermined distance, and
the second drive mechanism moves the first support member in the longitudinal direction.

6. The drilling apparatus according to claim 3, wherein
the second drive mechanism moves the spindle relative to the workpiece and the steady rest member in the longitudinal direction while maintaining the relative position between the workpiece and the steady rest member in the longitudinal direction.

7. The drilling apparatus according to claim 6, further comprising:
a first support member configured to support the first drive mechanism, on which the workpiece is placed; and
a second support member configured to support the spindle, wherein
the steady rest member is fixed to the first support member at a position spaced apart from the end face of the workpiece in the longitudinal direction by a predetermined distance, and
the second drive mechanism moves the second support member in the longitudinal direction.

8. The drilling apparatus according to claim 1, wherein
the workpiece is disposed to have the longitudinal direction aligned with a horizontal direction parallel to an installation surface, when the drilling apparatus has been installed on the installation surface, and
the spindle holds the machining tool while the machining tool is disposed along the horizontal direction.

9. The drilling apparatus according to claim 1, wherein
the workpiece is disposed to have the longitudinal direction aligned with a vertical direction perpendicular to an installation surface, when the drilling apparatus has been installed on the installation surface, and
the spindle holds the machining tool while the machining tool is disposed along the vertical direction.

10. The drilling apparatus according to claim 1, wherein
the workpiece is a glass material that will serve as a clad of a multicore fiber preform, and
the at least one hole is a plurality of holes that allow a plurality of respective core rods to be inserted into the plurality of holes, the core rods being to serve as a plurality of cores of the multicore fiber preform.

11. A drilling method comprising:
a step of preparing a machining tool extending along a longitudinal direction of a workpiece having a cylindrical shape, a spindle disposed at a position facing an end face of the workpiece in the longitudinal direction, the spindle configured to rotatably hold the machining tool, and a steady rest member disposed between the end face and the spindle in the longitudinal direction;
a step of moving the workpiece relative to the spindle and the steady rest member in a direction orthogonal to the longitudinal direction to cause the machining tool to face, in the longitudinal direction, the end face at an arbitrary position on the end face; and
a step of moving at least one of the workpiece and the spindle in the longitudinal direction to cause at least one hole to be formed at the arbitrary position on the end face by the machining tool.
